(19) United States
(12) Patent Application Publication
(10) Pub. No.: US 2007/0283139 A1
(43) Pub. Date: Dec. 6, 2007

(54) Information processing apparatus and control method used thereby

(75) Inventor: Yoshiyuki Kato, Kokubunji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/785,783

(22) Filed: Apr. 20, 2007

(30) Foreign Application Priority Data
Apr. 28, 2006 (JP) 2006-126945

(51) Int. Cl. G06F 9/00

(52) U.S. Cl. 713/2

(57) ABSTRACT

According to one embodiment, an information processing apparatus is connected to a memory in which configuration information is stored in predetermined fixed addresses and a boot program is stored in addresses other than the fixed addresses. Based on a resetting request issued on startup, the configuration information is read out from the fixed addresses of the memory. After settings for hardware processing have been performed on the basis of the readout configuration information, a CPU unit is started up. As a result, a memory controller reads out the boot program by accessing the memory and the CPU unit to execute the boot program.

### CROSS-REFERENCE TO RELATED APPLICATIONS

This application is based upon and claims the benefit of priority from Japanese Patent Application No. 2006-126945, filed Apr. 28, 2006, the entire contents of which are incorporated herein by reference.

### BACKGROUND

1. Field

One embodiment of the present invention relates to an information processing apparatus and a control method used thereby, and more particularly to booting means.

2. Description of the Related Art

Recently, semiconductor apparatuses such as LSI devices and the like have been remarkably popularized, and basic performances thereof have been required to be at high levels. In a microcomputer device such as an LSI device or the like, a boot program, a user program, and configuration information are loaded by booting up the device, and boot process according to the boot program and processing of the user program are carried out.

In Patent Document 1 (Jpn. Pat. Appln. KOKAI Publication No. 6-187195), there is disclosed a control system which is a setting control system, and in which setting information is stored in an external nonvolatile memory, and is loaded into an LSI at the time of power-on to be set.

In Patent Document 1, however, no consideration is given as to how to effectively load configuration information, a boot program, a user program or the like from an external memory.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one example of a structure of an information processing apparatus according to one embodiment of the present invention;

FIG. 2 is an explanatory diagram showing one example of configuration of the information processing apparatus according to one embodiment of the present invention;

FIG. 3 is a block diagram showing one example of another structure of the information processing apparatus according to one embodiment of the present invention;

FIG. 4 is a flowchart showing one example of boot process of the information processing apparatus according to one embodiment of the present invention;

FIG. 5 is a timing chart showing one example of boot process of the information processing apparatus according to one embodiment of the present invention; and

FIG. 6 is an explanatory diagram showing one example of configuration information of the information processing apparatus according to one embodiment of the present invention.

### DETAILED DESCRIPTION

Various embodiments according to the invention will be described hereinafter with reference to the accompanying drawings. In general, according to one embodiment of the invention, an information processing apparatus is connected to a memory in which configuration information is stored in predetermined fixed addresses and a boot program is stored in addresses other than the fixed addresses. Based on a resetting request issued on startup, the configuration information is read out from the fixed addresses of the memory. After settings for hardware processing have been performed on the basis of the readout configuration information, a CPU unit is started up. As a result, a memory controller reads out the boot program by accessing the memory and the CPU unit to execute the boot program.

Hereinafter, the embodiment of the present invention will be described in detail with reference to the drawings.

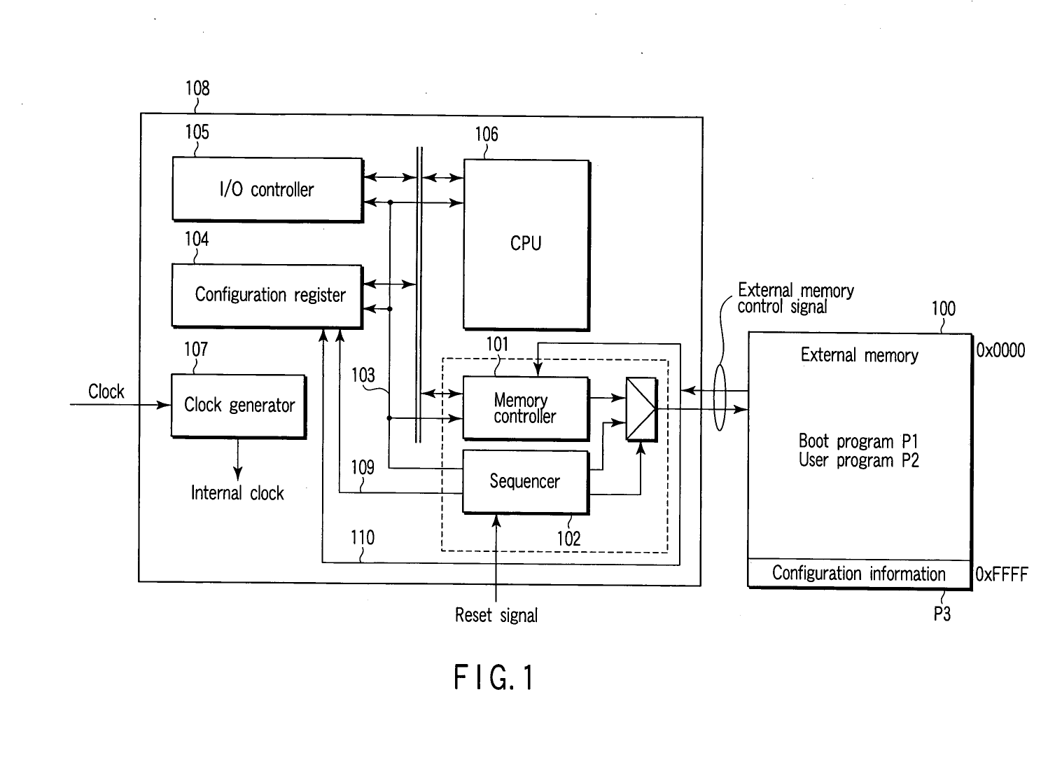

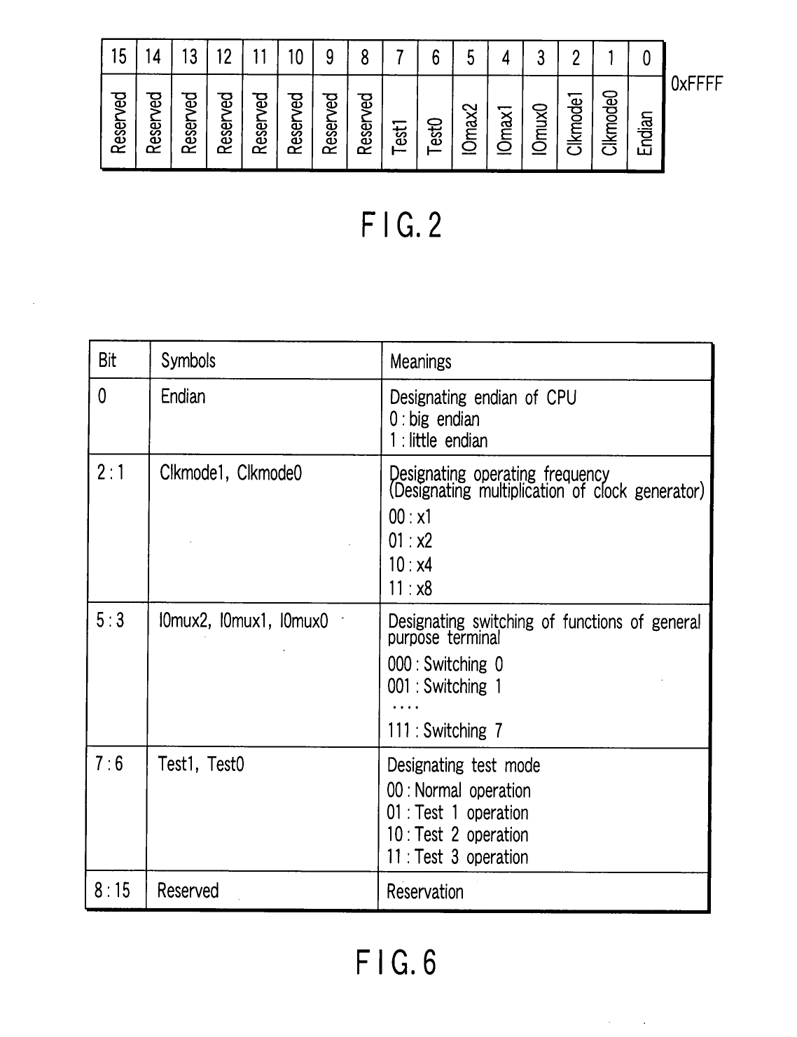

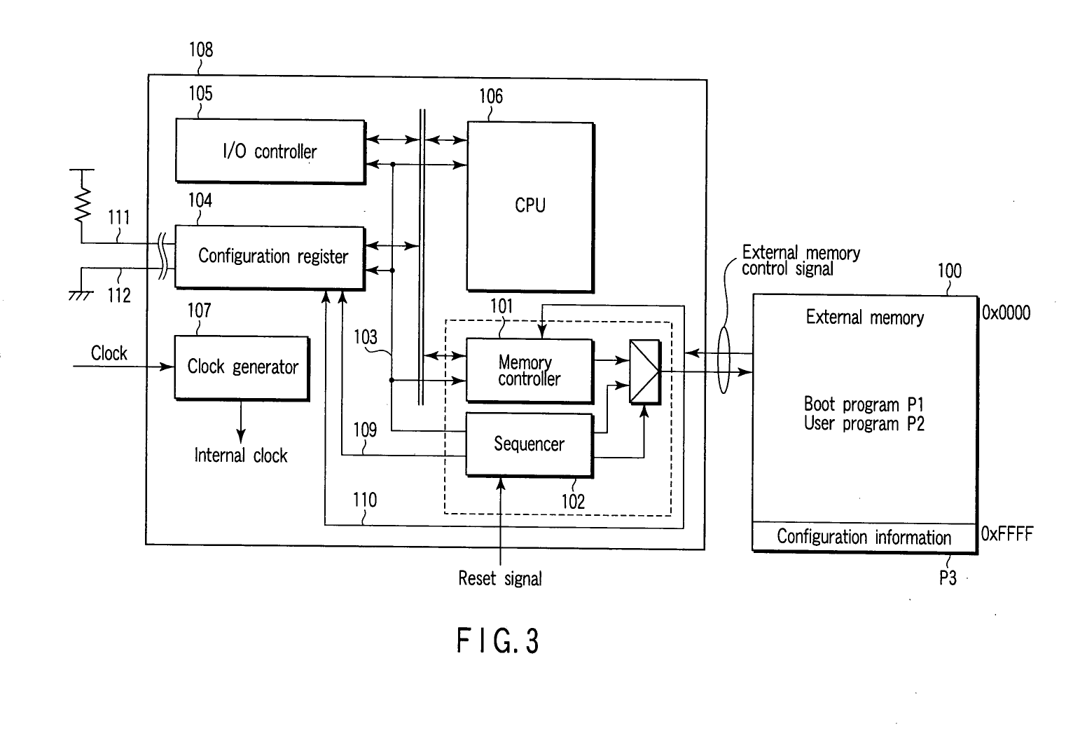

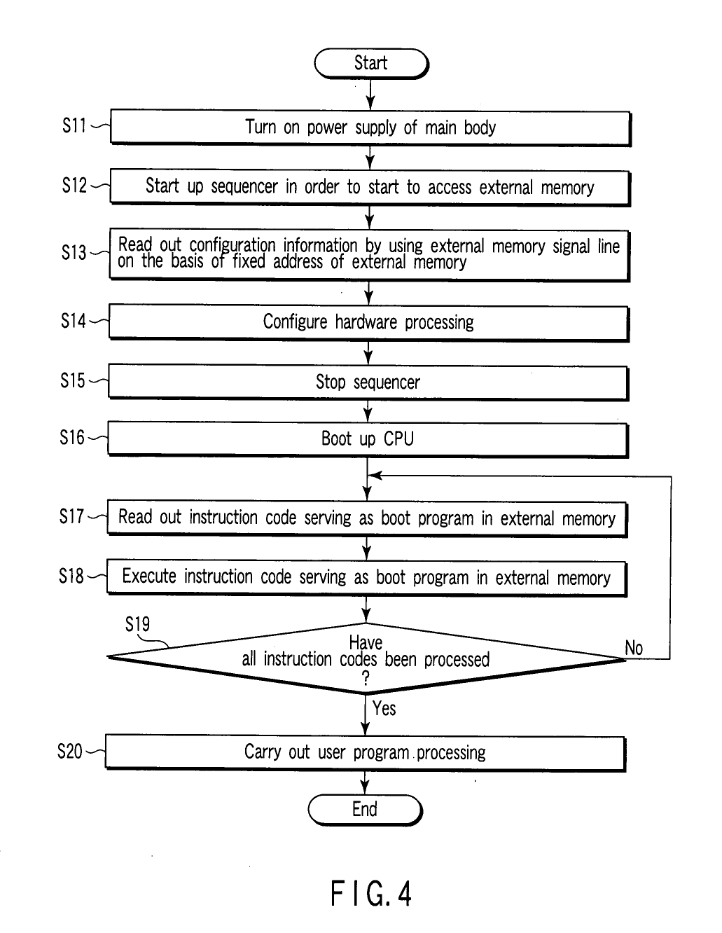

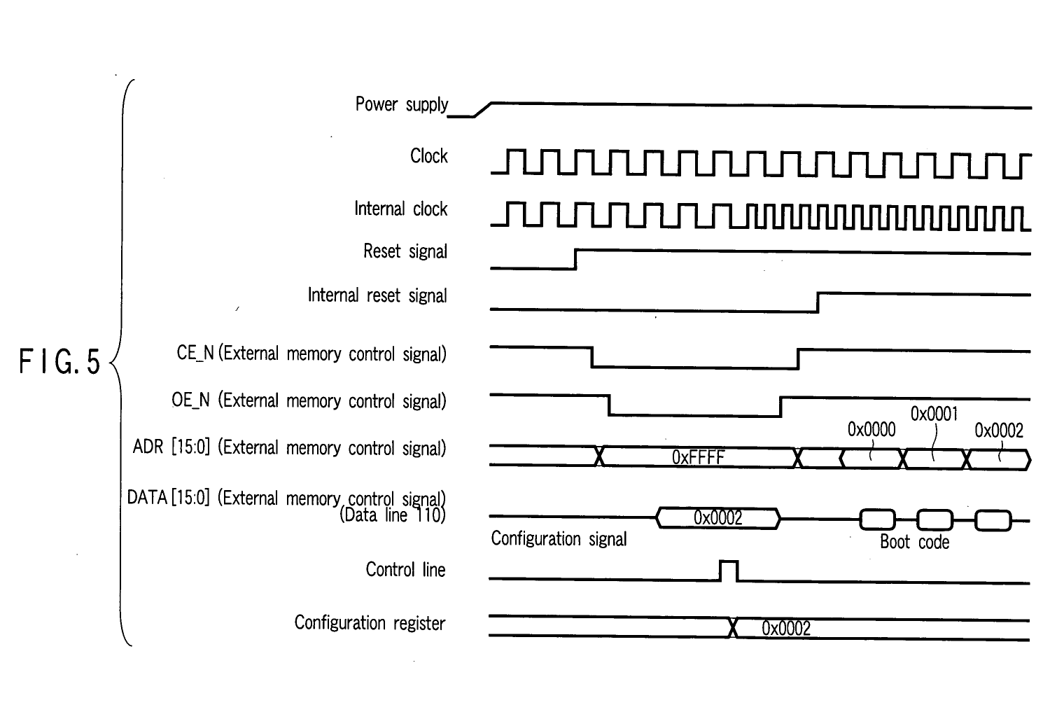

FIG. 1 is a block diagram showing one example of a structure of an information processing apparatus according to one embodiment of the present invention. FIG. 2 is an explanatory diagram showing one example of configuration of the information processing apparatus. FIG. 3 is a block diagram showing one example of another structure of the information processing apparatus. FIG. 4 is a flowchart showing one example of boot process of the information processing apparatus. FIG. 5 is a timing chart showing one example of boot process of the information processing apparatus. FIG. 6 is an explanatory diagram showing one example of configuration information of the information processing apparatus.

<Information Processing Apparatus Serving as One Embodiment According to the Present Invention>

(Structure)

An information processing apparatus 108 serving as one embodiment of the present invention is, as shown in FIG. 1, connected to a single external memory 100, and external memory control signals and stored data are transmitted and received therebetween. A data width of the external memory is set to be 16 bits. The information processing apparatus 108 has a CPU 106 connected to a data bus, an IO controller 105 connected to the data bus, a configuration register 104 which stores configuration information and is connected to the data bus, and a clock generator 107 which supplies an internal clock used for operations of the entire system. Here, internal reset signals 103 are supplied to the respective units from a sequencer 102. Moreover, a control line 109 is supplied from the sequencer 102 to the configuration register 104, and a data line 110 is connected between a memory controller 101 and the configuration register 104.

Further, one example of the configuration information is shown in FIG. 2, and the information is stored at an FFFF address of the external memory 100. The configuration information is 16-bit information in which bit 00 to bit 07 represent various types of signals and bit 08 to bit 15 are “Reserved.”

Further, the information processing apparatus 108 shown in FIG. 3 further has a resistor and a power supply potential 111 which are connected to the outside of the configuration register 104, and provide configuration information by supplying predetermined potentials, and a ground potential 112. By varying electric potentials by the power supply potential and the resistor, it is possible to easily change the contents of the configuration information.

Namely, both of the configuration by a pull-up resistor or a pull-down resistor attached on the board, and the configuration based on the configuration information stored in the external memory are achieved. Then, default settings, such as switching of general purpose terminals, setting of a clock frequency, and the like, which depend on other parts mounted on the board are carried out by the pull-up or pull-down resistor on the board. In addition, settings, such as setting of endian serving as an operation mode of the CPU, and the like, which are required to be changed in accordance with a boot program and a user program on the external memory are carried out on the basis of configuration information to be stored in the external memory. In accordance therewith, the same external memory can be used even when the board is changed, which makes it possible to reduce the number of external memories prepared for each product. Further, there is no need to change the setting of the resistor on the board in accordance with a boot program or a user program.

In the information processing apparatus 108 having such a structure, a setting of hardware processing, boot process, and processing of the user program are carried out by using configuration information P3, a boot program P1, and a user program P2 which are stored in the single external memory 100. Here, the configuration information P3 is stored at a fixed address of the external memory, and a setting of hardware processing is achieved, which will be described in detail hereinafter by using the drawings and the flowchart.

(Boot Operations)

Next, the boot process of the information processing apparatus 108 serving as the one embodiment of the present invention will be described with reference to the flowchart of FIG. 4 and the timing chart of FIG. 5. First, when the power supply of the information processing apparatus 108 is turned on (step S11), the sequencer 102 starts the operations in a timing when reset signals are deasserted (step S12). Then, a read operation is started by asserting external memory control signals. Namely, it is switched such that a CE_N (chip enable), an OE_N (output enable), and an ADR [15:0] (address) are outputted in place of the memory controller 101. At this time, FFFF is outputted as an address in order to read the configuration information stored in the fixed address FFFF of the external memory. The external memory 100 outputs a value of the FFFF address at which the configuration information is stored, by using the data line 110. The configuration information P3 is read out on the data line 110 through a DATA [15:0] (step S13).

In the embodiment, suppose that the sequencer 102 accesses the external memory 100 in a fixed timing. This is because this access is made in the process of resetting, a request for a read time is not exact, and there is no problem as long as it is possible to access the external memory 100 at an appropriate speed.

Next, the sequencer 102 outputs a control signal from the control line 109, and hardware processing is set by storing the configuration information P3 read out on the data line 110 in the configuration register 104 (step S14). The default settings of the respective hardware inside the LSI 108 are determined in accordance with the contents of the configuration register 104. In the embodiment, the multiplication of the clock generator is set to ×2, and an internal clock frequency is determined. Further, here, FIG. 6 shows one example of the configuration information.

Next, the sequencer 102 carries out deassertion of the external memory control signals, and carries out deassertion of the internal reset signal 103, and the sequencer 102 is stopped (step S15).

When the internal reset signal 103 is deasserted, the CPU 106 starts to boot up (step S16), and starts instruction fetch with respect to the external memory 100 under the control of the memory controller 101. The CPU carries out boot process in accordance with the boot program P1 placed in the external memory.

Namely, the CPU reads out an instruction code serving as the boot program P1 in the external memory 100 (step S17), and executes the boot program P1 (step S18). This processing is continued until all instruction codes are processed (step S19).

Next, by reading out and sequentially executing an instruction code serving as the user program P2 in the external memory 100 (step S20), the information processing apparatus 108 according to the present invention operates in the steady state.

In this way, in the information processing apparatus 108 according to the present invention, in particular, by reading out the configuration information and the like on the basis of a fixed address of the single external memory, it is possible to carry out a setting of hardware processing, a boot process, and processing of the user program by using the configuration information P3, the boot program P1, and the user program P2 by the single external memory.

Namely, in accordance therewith, a serial ROM conventionally required for settings of hardware processing separately from the external memory is no longer required, and a complicated sequencer for controlling a serial ROM is no longer required. Further, terminals for controlling a serial ROM are no longer necessary. Moreover, a pull-up resistor or a pull-down resistor with respect to LSI terminals which has been conventionally required is no longer necessary, and there is no need to alter the board in accordance with a change in the settings.

### Other Embodiments

Moreover, as other embodiments, configuration information of an amount of a plurality of words is stored in the external memory 100. As addresses, an FFFE, an FFFE and the like are preferably used. The configuration information is read out by switching the addresses of the external memory 100 by the sequencer 102. In accordance therewith, the number of bits of the configuration information can be increased.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a memory configured to store configuration information in predetermined fixed addresses and a boot program in addresses other than the fixed addresses;
a sequencer configured to access the fixed addresses of the memory based on a resetting request issued on startup and read the configuration information;
a configuration register configured to store the configuration information read out from the memory, under control of the sequencer;
a CPU unit for which settings for hardware processing is performed based on the configuration information stored in the configuration register, the CPU unit being started up by the sequencer; and
a memory controller configured to read out the boot program by accessing the memory under the control of the CPU unit, and to cause the CPU unit to execute the boot program.

2. The information processing apparatus according to claim 1, further comprising:
a setting unit configured to change the configuration information stored in the configuration register, by externally applying a predetermined potential to the configuration register.

3. The information processing apparatus according to claim 2, wherein the setting unit applies the predetermined potential to the configuration register by using one of a pull-up resister and a pull-down resister.

4. The information processing apparatus according to claim 1, wherein:
the sequencer is configured to generate an internal resetting signal when the configuration information in the memory has been stored in the configuration register; and
the CPU unit is started up based on the internal resetting signal generated by the sequencer.

5. The information processing apparatus according to claim 1, further comprising:
a clock generator configured to determine a multiplication factor of the internal clock based on the configuration information stored in the configuration register.

6. The information processing apparatus according to claim 1, further comprising:
an IO controller configured to perform the settings for hardware setting based on the configuration information stored in the configuration register.

7. The information processing apparatus according to claim 1, wherein the memory is configured to store a user program in addresses other than the fixed addresses where the configuration information is stored and the addresses where the boot program is stored.

8. A control method for use in an information processing apparatus connected to a memory which is configured to store configuration information in predetermined fixed addresses and a boot program in addresses other than the fixed addresses, said method comprising:
causing a sequencer to access the fixed addresses of the memory based on a resetting request issued on startup and to read the configuration information;
causing a configuration register to store the configuration information read out from the memory, under control of the sequencer;
causing the sequencer to start up the CPU unit for which settings for hardware processing has been performed based on the configuration information stored in the configuration register; and
reading out the boot program by causing the memory controller to access the memory under the control of the CPU unit, and causing the CPU unit to execute the boot program.

9. The control method according to claim 8, further comprising:
changing the configuration information stored in the configuration register, by externally applying a predetermined potential to the configuration register.
